(19) United States
(12) Patent Application Publication
(10) Pub. No.: US 2008/0033905 A1
(43) Pub. Date: Feb. 7, 2008

(54) System and Method for the Capture and Archival of Electronic Communications

(75) Inventor: Terry Stokes, Redmond, WA (US)

Correspondence Address: TERRY L STOKES, 9200 REDMOND WOODINVILLE ROAD NE, APT D323, REDMOND, WA, 98052, US

(73) Assignee: Terry Lee Stokes, Redmond, WA (US)

(21) Appl. No.: 11/834,004

(22) Filed: Aug. 5, 2007

Related U.S. Application Data
(62) Division of application No. 11/833,997, filed on Aug. 4, 2007.
(60) Provisional application No. 60/821,564, filed on Aug. 5, 2006.

(51) Int. Cl. G06F 17/30

(52) U.S. Cl. 707/1

(57) ABSTRACT

A system and method for the capture and archival of electronic communication is disclosed. A network interface card in promiscuous mode connects the invention to an electronic communications network. Network packets are received on the network interface card and sent to a pseudo TCP/IP stack, which reconstructs the network packets into the original electronic message. The reconstructed electronic message is transferred to the traffic capture component in chunks until the entire message is captured. The traffic capture component forwards the electronic message to the message analysis component, which hashes, parses, analyzes and formats for storage the electronic message. The electronic message, in a structured format, is then sent to the storage manager component. The storage manager component selects a storage unit from the available network storage based on the message hash. The storage manager component then compresses, encrypts and writes the structured version of the electronic message to the selected storage unit. The message analysis component also writes Meta Data information and keywords from the electronic message to the index database. Once an electronic message is captured and archived, it can be later retrieved using the message query/retrieval component. To retrieve a previously archived electronic message, a user first sends a query specifying the messages desired to the message query/retrieval component using the user interface. The message query/retrieval component formats the query in SQL and runs it against the index database. The message query/retrieval component also sends the query to any other instances of the invention in the electronic communications network via the communications interface. The results of the query from the index database and the other c instances of the invention are combined, formatted for display and returned to the user via the user interface. From the query results, the user can select one or more archived electronic messages to be viewed by sending a list of messages to the message query/retrieval component using the user interface. The message query/retrieval component forwards this list to the storage manager component, which reads, decrypts and decompresses each message from the list in turn and writes the structured message formatted for display to a disk file. When complete, the storage manager component informs the message query/retrieval component, which in turn notifies the user via the user interface. The policy component is used to modify the behavior of the traffic capture, message analysis and message query/retrieval components. Within the traffic capture component, the policy is used to determine whether a particular electronic message is captured or not. Within the message analysis component, the policy is used to determine what type of message analysis to perform and what the storage attributes of the message should be. Within the message query/retrieval component the policy is used to determine whether a user can access the message archive and to filter the query results.

### REFERENCES CITED

T. Stokes, “Product specification for compliance appliance,” 26 pages, August 2005.

### FIELD OF THE INVENTION

The present invention relates generally to capture and archival of electronic communications. More specifically, the present invention relates to techniques for capture, analysis, storage and retrieval of electronic communications, such as, but not limited to, email, instant messaging, web pages, SMS and voice over IP.

### BACKGROUND OF THE INVENTION

The use of electronic communications, such as email, instant messaging, web pages, SMS and voice over IP, has become prevalent in the business world. Over the years, as electronic communications have supplanted the use of paper communications, it has become more and more important to find a way to store copies of these electronic messages.

There are many reasons that business communications in general need to be stored in searchable archives. Many government regulations, such as Sarbanes Oxley, HIPAA, Patriot Act, GLB and SEC, require that business communications be archived for a number of years. Evidentiary discovery rules require the production of business communications pertinent to the issues in a case. And corporate governance requires the archival of important business communications.

In the past, the archival of business communications was limited to paper communications, such as letters and accounting books. As email came into wide usage, the archival of emails became a regulatory requirement, but mostly limited to financial institutions. In the last five years, due to the increased prevalence of electronic communications and the increase in government regulations as a result of several accounting scandals, nearly all companies are required to archival some amount of email and instant messages.

Most products in the field are software based and limited to archival of a single protocol. This is a major disadvantage, as the products have difficulty archiving additional protocols due to new regulatory requirements. For example, KVS's software product, the Enterprise Vault, was developed to archive MS Exchange emails. Emails were captured using a feature in MS Exchange called “journaling”. The journaling mechanism simple places a copy of each email received by the MS Exchange server in a special email account. The Enterprise Vault software periodically access the email account using POP3, much like any user would, and downloads any new emails to its archives.

This method does not work for instant messaging archival, a requirement the SEC added recently. To support instant messaging archival, KVS teamed with Facetime Communications, whose product is used to control instant messaging traffic within a network. A plug-in to the Facetime product allows instant messages to be captured and forwarded to the KVS product for archival. So to archive email and instant messages, three products need to be installed and maintained: KVS, Facetime and a KVS plug-in for Facetime. Since a multitude of electronic messaging protocols are being used today, any of which could be required to be archived in the near future, the solution of adding more software packages will soon become overly cumbersome.

Another disadvantage to the current approach is the use of journaling MS Exchange servers to capture emails. This is problematic in that each mailbox on every MS Exchange server needs to be configured for journaling. Since large companies have hundreds of users and many MS Exchange servers, this can be a daunting task. Additionally, as new users and servers are added to the network, additional configuration needs to be performed to continue capture of all network messages.

Performance is also an issue with the current approach. Nearly all the products in the field of invention are software products running on a generic OS, such as Microsoft Windows Server. Captured emails are stored in a single storage unit, such NAS storage, with indexing data stored in a third party database, such as Microsoft SQL Server. The archival product has little control over the operating environment and therefore cannot be optimized as well as an integrated appliance product. The product is simply a piece in the archival “system”.

### SUMMARY OF THE INVENTION

The present invention provides techniques for capture, analysis, storage and retrieval of electronic communications. It provides these capabilities as a single integrated architecture, as a dedicated appliance in the preferred embodiment. Since the invention sits at strategic points in the electronic communications network path, it is able to capture all electronic communications that take place on the network.

In the preferred embodiment, the invention consists of a network interface card, a pseudo TCP/IP stack, a traffic capture component, a message analysis component, a storage manager component, an index database, network storage, a message query/retrieval component, a policy component, a communications interface and a user interface. Generally, network packets are captured by the network interface card in promiscuous mode and forwarded to the pseudo TCP/IP stack, which reconstructs the electronic message in chunks. Each chunk is passed on to the traffic capture component, which handles extracting the electronic message from the underlying transport protocol and determining whether the message should be captured via rules provided by the policy component.

After the message is captured it is forwarded to the message analysis component, which parses the message and separates out all the attachments. The message and attachments are also converted to a structured format. Policy rules are executed within the message analysis component to determine storage attributes and whether additional analysis should be performed. The message and the attachments are then transferred to the storage manager component, which selects a storage unit from a storage grid based on a hashes of the message and attachments, each of which are stored separately. Meta data and keywords extracted from the message are stored in the index database.

Once the message is archived, queries can be run against the index database to later retrieve the archived messages. A user issues a query to the message analysis component via the user interface. The message analysis component runs the query against all instances of the invention in the network (including itself) via the communications interface and returns the interactive results to the user, filtering as appropriate per policy. The user can then select a list of messages to retrieve from the query results. The list of messages is passed down to the storage manager component, which locates, reads and formats for display the messages, which are then written to a disk file. The disk file can either be saved for downloading or viewed by the user.

### BRIEF DESCRIPTION OF DRAWINGS

FIG. 1 shows an example of an electronic communications network containing the invention.

FIG. 2 shows the components of the preferred embodiment of the present invention.

FIG. 3 is a block diagram illustrating a method of the present invention for capturing electronic messages.

FIG. 4 is a block diagram illustrating a method of the present invention for parsing, formatting for storage and analyzing captured electronic messages.

FIG. 5A shows the structured message format of the preferred embodiment of the present invention.

FIG. 5B shows an example of the Meta Data portion of the structured message format of the preferred embodiment.

FIG. 6A is a block diagram illustrating a method of the present invention for preparing and writing electronic messages to network storage.

FIG. 6B shows an example of a storage network containing the invention.

FIG. 6C shows an example of a network storage information table of the preferred embodiment of the present invention.

FIG. 7A is a block diagram illustrating a method of the present invention for executing a user query and returning interactive results.

FIG. 7B is a block diagram illustrating a method of the present invention for executing a query against the index database of archived electronic messages for a single instance of the invention.

FIG. 7C shows an example of a query history and the related predictive query of the preferred embodiment of the present invention.

FIG. 7D is a block diagram illustrating a method of the present invention for executing predictive queries.

FIG. 8 is a block diagram illustrating a method of the present invention for retrieval of archived electronic messages.

FIG. 9A shows an example of a policy rule set of the preferred embodiment of the present invention.

FIG. 9B is a flow diagram describing the Policy Enforcement Points (PEP) of the preferred embodiment of the present invention.

### DETAILED DESCRIPTION OF THE INVENTION

The present invention will be illustrated below in conjunction with an exemplary electronic communications network. It should be understood, however, that the invention is not limited to use with any particular type of network storage, network interface card, messaging server or any other type of network or computer hardware. It should also be understood that while the term “electronic message” is used in the description, the invention is not limited to message based electronic communications. In alternative embodiments, the invention can capture and archive non-traditional electronic communications, such as files transported via FTP, web pages over HTTP, or stock ticker messages. Moreover while the preferred embodiment takes the form of a capture/archival appliance, the invention can also be delivered as one or more software products as alternative embodiments.

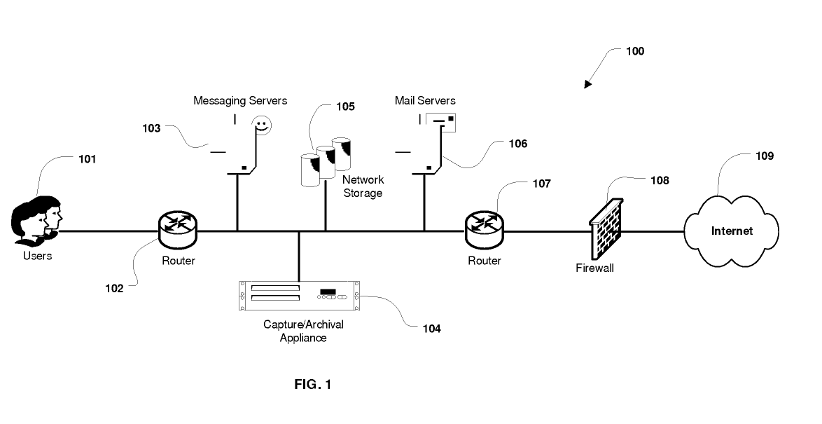

FIG. 1 shows an example of an electronic communications network showing the preferred embodiment of the present invention. This is a simplified example used to illustrate how the invention is used within an electronic communications network. It should be noted that that in most every case, the actual electronic communications network will be much more complex and will nearly always contain multiple instances of the present invention. The need for multiple instances of the invention is required due to the multiple paths an electronic message can take and the need for load balancing and redundancy. In an actual network, one or more instances of the invention would be placed at different points in the network to cover any possible path a message can take between the sender and the recipients.

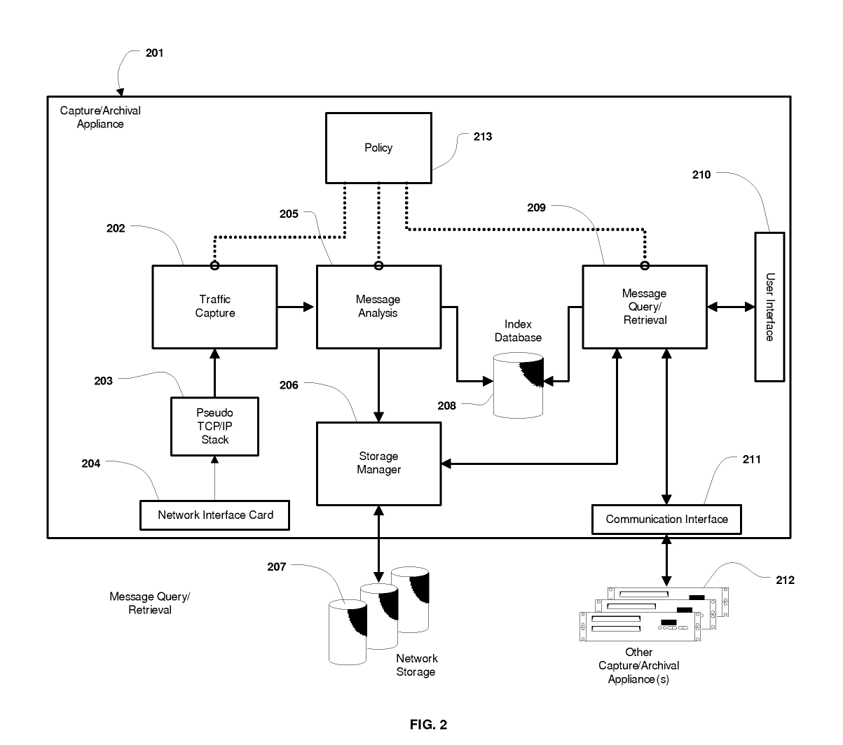

In the example electronic communications network in FIG. 1, users 101 send and receive electronic messages. If the electronic messages are to other users within the electronic communications network, the messages will be routed to either the messaging servers 103 or the mail servers 106 via the router 102. If the electronic messages are to users outside the electronic communications network, the messages will be routed past the firewall 108 to the Internet 109 via router 102 and router 107. In either case, the electronic messages travel on the network past the capture/archival appliance 104, whose network interface card is in promiscuous mode. The capture/archival appliance 104 captures the network packets comprising an electronic message and reconstructs the message. The capture/archival appliance 104 writes a structured version of the electronic message to the network storage 105. The capture/archival appliance 104 is described in greater detail in FIG. 2.

FIG. 2 shows an internal view of the preferred embodiment of the present invention, namely the capture/archival appliance 201. A network interface card 204 in promiscuous mode connects the appliance to the electronic communications network. Network packets are received on the network interface card 204 and sent to a pseudo TCP/IP stack 203. The pseudo TCP/IP stack 203 reconstructs the network packets into the original electronic message. There are several open source packages, such as libpcap, libnet and libnids, which can be used to implement pseudo TCP/IP stacks as needed by the invention. In an alternative embodiment, the appliance works as a proxy server, in which case all desired messaging traffic is proxied through the invention, allowing electronic messages to be captured directly.

The pseudo TCP/IP stack 203 transfers the reconstructed electronic message to the traffic capture 202 component in chunks until the entire message is captured. The traffic capture 202 component forwards the electronic message to the message analysis 205 component, which hashes, parses, analyzes and formats for storage the electronic message. The electronic message, in a structured format, is then sent to the storage manager 206 component. The storage manager 206 component selects a storage unit from the available network storage 207 based on the message hash. The storage manager 206 component then compresses, encrypts and writes the structured version of the electronic message to the selected storage unit. The message analysis 205 component also writes Meta Data information and keywords from the electronic message to the index database 208. There are several open source database packages, such as MySQL, PostgreSQL and Lucerne, which can be used to implement both Meta Data and keyword support in the index database 208.

Once an electronic message is captured and archived, it can be later retrieved using the message query/retrieval 209 component. To retrieve a previously archived electronic message, a user first sends a query specifying the messages desired to the message query/retrieval 209 component using the user interface 210. The message query/retrieval 209 component formats the query in SQL and runs it against the index database 208. The message query/retrieval 209 component also sends the query to any other capture/archival appliances 212 in the electronic communications network via the communications interface 211. The results of the query from the index database 208 and the other capture/archival appliances 212 are combined, formatted for display and returned to the user via the user interface 210. From the query results, the user can select one or more archived electronic messages to be viewed by sending a list of messages to the message query/retrieval 209 component using the user interface 210. The message query/retrieval 209 component forwards this list to the storage manager 206 component, which reads, decrypts and decompresses each message from the list in turn and writes the structured message formatted for display to a disk file. When complete, the storage manager 206 component informs the message query/retrieval 209 component, which in turn notifies the user via the user interface 210.

The policy 213 component is used to modify the behavior of the traffic capture 202, message analysis 205 and message query/retrieval 209 components. Within the traffic capture 202 component, the policy 213 is used to determine whether a particular electronic message is captured or not. Within the message analysis 205 component, the policy 213 is used to determine what type of message analysis to perform and what the storage attributes of the message should be. Within the message query/retrieval 209 component the policy 213 is used to determine whether a user can access the message archive and to filter the query results.

Many alternatives to the preferred embodiment should be readily apparent to a person knowledgeable in the art. One alternative embodiment is to store electronic messages on internal storage within the capture/archival appliance rather than external network storage. Still another alternative embodiment is to employ a single index database located on network storage accessible by all capture/archival appliances within the electronic communications network, rather than having separate index databases for each capture/archival appliance.

The traffic capture 202, message analysis 205, storage manager 206, message query/retrieval 209 and policy 213 components are further detailed in the sections below. Parts of the policy 213 component are also detailed in the traffic capture 202, message analysis 205, and message query/retrieval 209 components to illustrate the interactions between the two components.

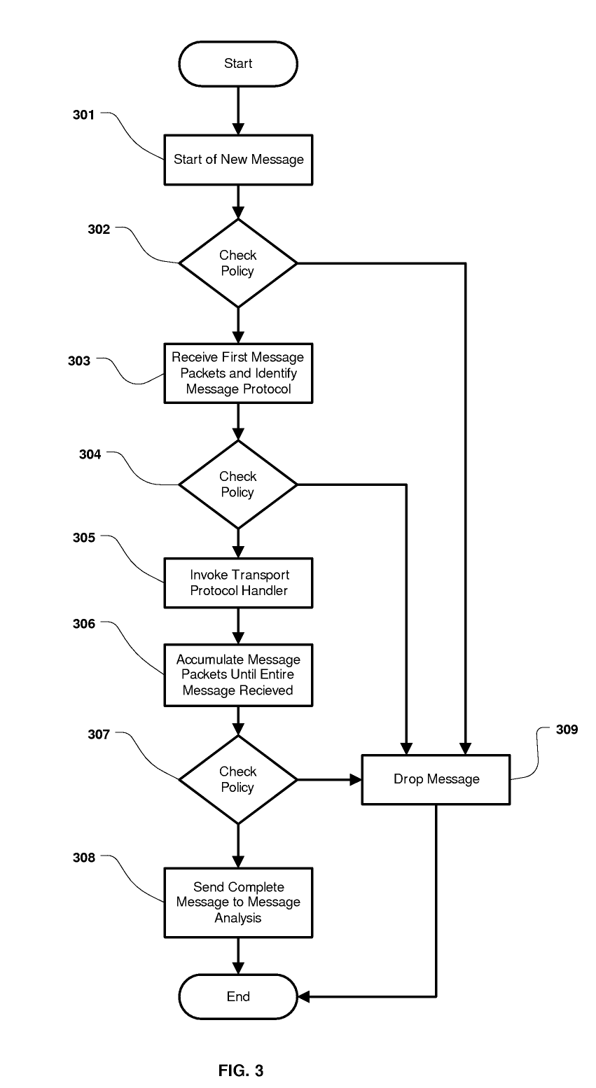

FIG. 3 is a block diagram illustrating a method of the present invention for capturing electronic messages (the traffic capture 202 component). After the first few packets of a message, captured via the network interface card 204 in promiscuous mode, are reconstructed by pseudo TCP/IP stack 203, a call into the traffic capture 202 component is made. This call is reflected in step 301. At this point the policy is checked 302 to determine whether we want to continue capturing the message or whether the message can be dropped 309. If the policy does not resolve to a rule to drop the message, in step 303, the transport (SMTP, MS-RPC, HTTP, Yahoo IM, SIP, etc.) and message protocol (mime, html, MSN IM, Yahoo IM, VoIP, etc.) is identified. In step 304, the policy is again checked to determine whether the message should continue or should be dropped 309. If the policy still does not resolve to a rule to drop the message, in step 305 a transport protocol handler is invoked. The transport protocol handler strips out transport layer headers and packets, leaving only the electronic message. For example, a SMTP transport protocol handler would strip out the HELO, MAIL FROM, RCPT TO, QUIT, etc. transport layer messages and only save the contents of the DATA packets, which contains the actual email message. The transport protocol handler also detects application layer errors, so that partial or corrupted messages are no stored.

In step 306, the transport protocol handler is used to accumulate data received from the pseudo TCP/IP stack 203 until the entire message is captured. At this point, the policy is checked 307 to determine whether the message should be saved or dropped 309. If policy determines the message should be saved, in step 308 the complete message is forwarded on to message analysis 205. If any of the policy steps 302, 304 or 307 determines to drop the message, in step 309 the pseudo TCP/IP stack 203 is informed to stop capture of this particular message and all packets related to this message are thrown away.

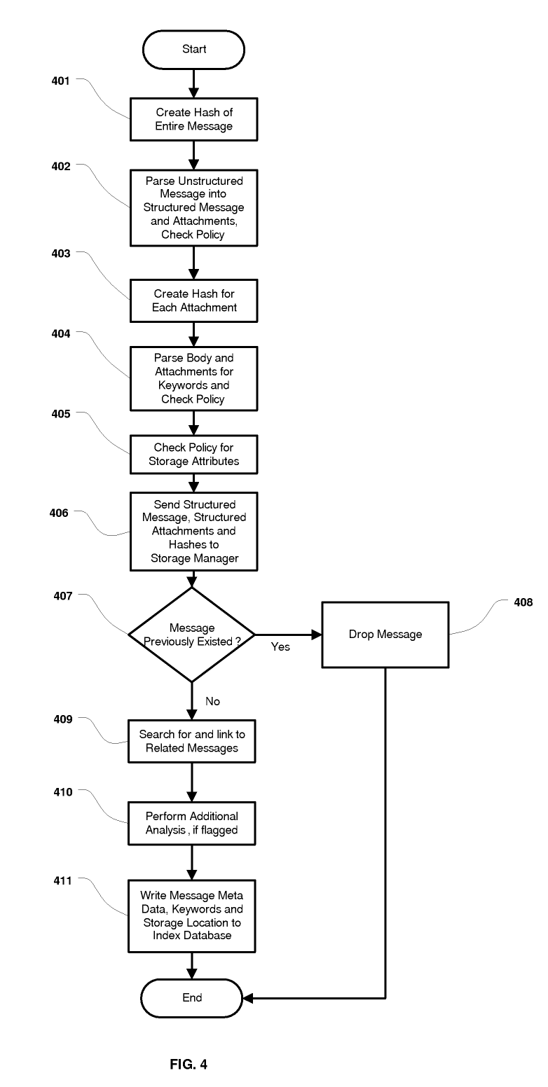

FIG. 4 is a block diagram illustrating a method of the present invention for parsing, formatting for storage and analyzing captured electronic messages (the message analysis 205 component). At the start of step 401, a complete message is received from the traffic capture 202 by message analysis 205. A hash of the complete message is created using a standard algorithm such as MD5 or SHA. In step 402, the unstructured captured message is processed using a parser specific to the message protocol (mime, html, MSN IM, Yahoo IM, VoIP, etc.). As part of the processing by the message protocol parser, the unstructured message is transformed into a generic structured message format 501 and any embedded attachments are separated out. The message is transformed into a structured message format 501 to allow quick analysis and display formatting of the message. The embedded attachments are separated out to reduce storage usage, since the same attached file could be present in hundreds of captured messages. For the same reason given above for messages, each separated embedded attachment is transformed into a structured message format 501.

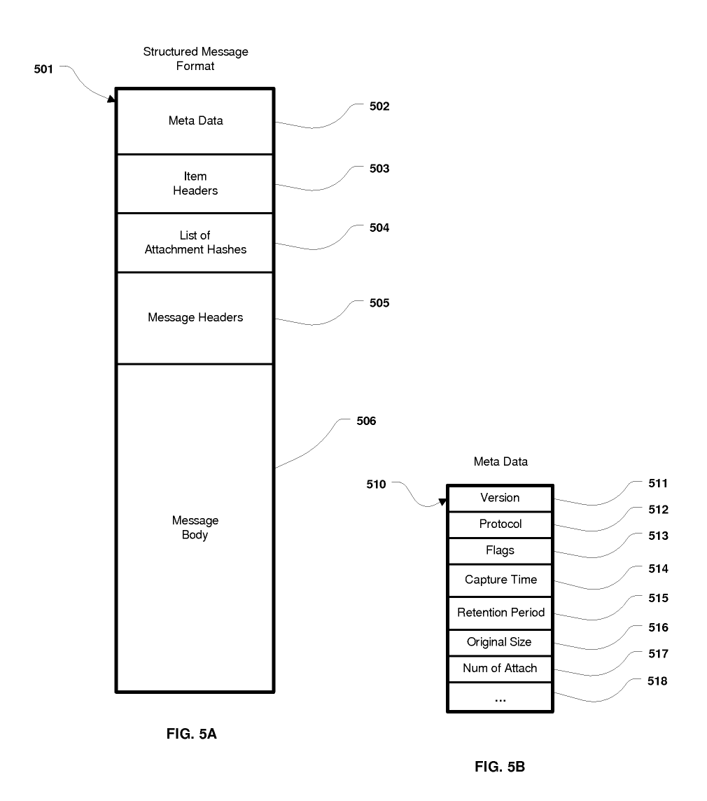

FIG. 5A generally illustrates the structured message format 501 produced by the message protocol parser. At the beginning of the structure is Meta Data 502 that describes the message. FIG. 5B shows a granular view of the contents of the Meta Data 510 section. Among other things, it contains the structure format version 511, the message protocol 512, a set of flags 513 to signal special characteristics of the message, such as policy violation, the time the message was captured 514, the retention period for the message, the original size of the message 516 when captured and the number of attachments 517. The Meta Data 510 section may contain additional information 518.

In FIG. 5A, after the Meta Data 502 section is the item headers 503 section. The item headers 503 describe where to find message items (headers and body) in the structured message 501. Each item header consists of item type followed by an item offset. There is an item type for each type of header and body for the message protocol. The item offset is the distance from the beginning of the structured message the item type is located. A special item type is used to signal the end of the item headers.

After the item headers 503 section is the list of attachment hashes 504 unless the message has no attachments, as indicted by the number of attachments 517 in the Meta Data 510 section of FIG. 5B. After the list of attachment hashes 504 is the message headers 505 section and at the end of the structured message 501 is the body of the message 506.

In step 402, after the unstructured captured message is converted into a generic structured message format 501 and the embedded attachments are separated out, the policy is checked to see if the message should be flagged based on the items in the message. In step 403, a hash of the each separated attachment is created using a standard algorithm such as MD5 or SHA. The list of attachment hashes 504 are added to the structured message 501 and the number of attachments 517 is updated. In step 404, the message body and each separated attachment is parsed for keywords, such as those used in search engines. The policy is again checked to see if additional message analysis is needed, and flagged for later processing.

In step 405, the policy is checked to determine what storage attributes, such as retention period, should be applied. In the next step 406, the structured message, the separated structured attachments and the hashes created in steps 401 and 403 are sent to the storage manager 206. After the storage manager 206 processes the message and attachments, it will return the results of the operation. In step 407, if the result was that the message already existed (because it was earlier captured by another capture/archival appliance), then the message is dropped 408 and processing stops. If the result was that the messages did nor exist, additional message analysis occurs. In step 509, analysis is performed to see if this message is related to previously captured messages. For example, a message could be linked as related to other messages because all are part of an email thread, either identified by a common thread id or by the same subject line. As another example, an analysis of two messages could be linked as related because in one the user refers to IBM as “Big Blue” and in another the user says “Big Blue” will report bad earnings. Related messages do not have to all use the same message protocol; a set of email, IM and VoIP messages could all be part of the same conversation topic.

In step 410, if flagged by policy in step 404, additional analysis is performed. This analysis ranges from searching for social security numbers to analysis for regulatory compliance violations. In step 411, the message Meta Data 510, the keywords from step 404 and the message storage location returned from the storage manager 210 is written to index database.

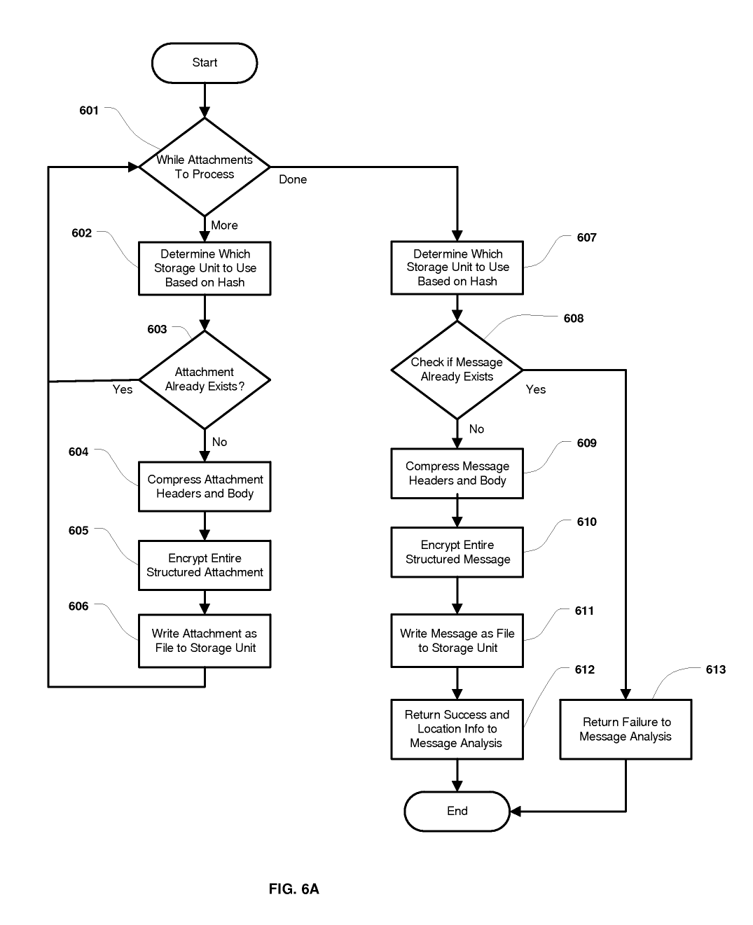

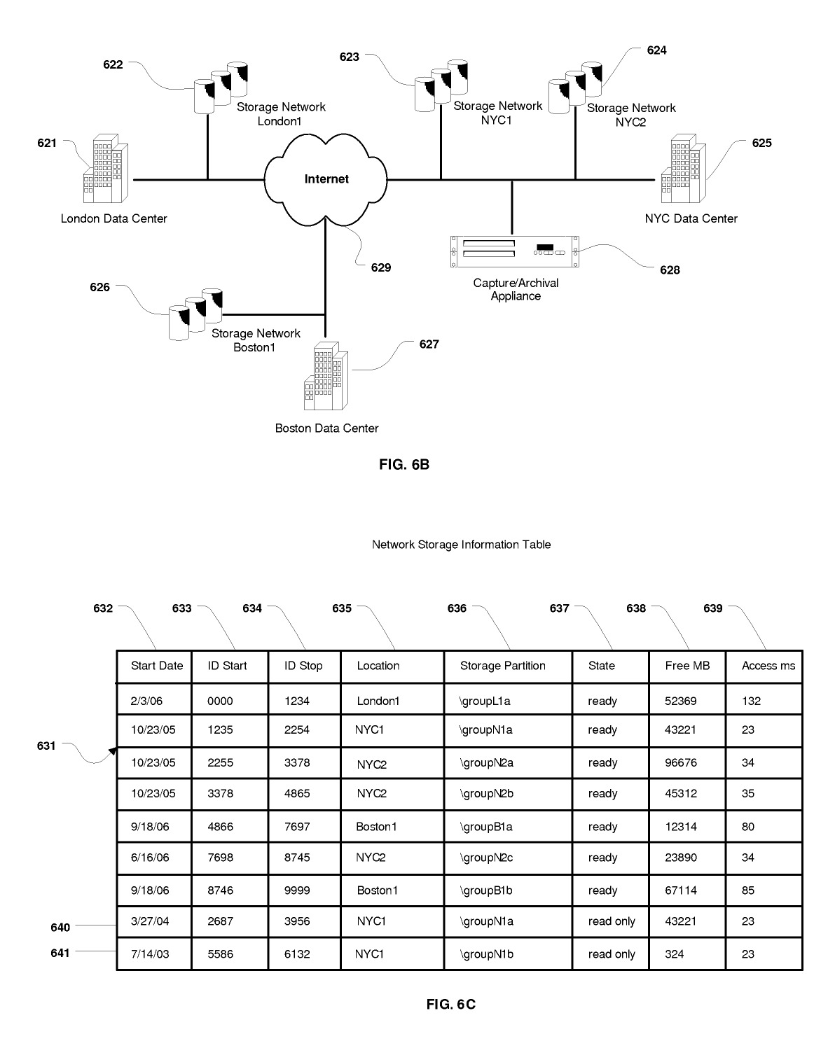

FIG. 6A is a block diagram illustrating a method of the present invention for preparing and writing electronic messages to network storage (the storage manager 206 component). At the start of step 601, the structured message, the separated structured attachments and the hashes created in steps 401 and 403 are received by the storage manager 206 from message analysis 205. In a loop from step 601, each received attachment is processed by steps 602, 603, 604, 605 and 606. In step 602, the attachment's hash is used to locate the storage unit the attachment should be written to. This process is described in greater detail in the discussion of FIG. 6B and FIG. 6C. In step 603, the attachment hash created in step 403 is used as a filename to determine if the attachment already exists on the selected storage unit. If the attachment already exists, the current attachment is skipped and the next attachment is processed in step 601. If the attachment doesn't exist, in step 604, the headers 505 and body 506 sections of the structured attachment are compressed using a well known compression algorithm such as zlib or LZW. In step 605, the entire structured attachment, including the now compressed headers 505 and body 506 sections are encrypted using a well known encryption algorithm, such as 3DES or RC4 using a session key that is randomly created at set intervals. The session key itself is encrypted using public key encryption and stored at the beginning of the encrypted attachment. In step 606, the encrypted attachment, including the encrypted session key, is written to the selected storage unit as a file with the attachment hash created in step 403 as the name of the file. After the file is written, returning to step 601, the next attachment is processed.

After all structured attachments are processed; the structured message itself is processed. As can be seen, the processing of the message follows a similar path as the attachments. In step 607, the message's hash is used to locate the storage unit the message should be written to. In step 608, the message hash created in step 401 is used as a filename to determine if the message already exists on the selected storage unit. If the message already exists, a failure result is returned to message analysis 205 in step 613 and processing is ended. If the message doesn't exist, in step 609, the headers 505 and body 506 sections of the structured message are compressed in the same manner as the attachments. In step 610, the entire structured message, including the now compressed headers 505 and body 506 sections are encrypted in the same manner as the attachments. In step 611, the encrypted message, including the encrypted session key, is written to the selected storage unit as a file with the message hash created in step 401 as the name of the file. After the file is written, in step 612, the storage manager 206 returns a success result to the message analysis 205.

FIG. 6B shows an example of a storage network containing the invention (capture/archival appliance) and multiple storage locations. The diagram shows three data centers, in London 621, Boston 627 and New York 625. The capture/archival appliance 628 is located on the New York network. The London data center 621 has one storage network 622. The Boston data center 627 has one storage network 626. The New York data center has two storage networks, 623 and 624. All of the storage networks are accessible to the capture/archival appliance 628 via the Internet 629. In the prefer embodiment, the storage networks are SAN based. Alternative embodiments can utilize other storage configurations, such as NAS or internal storage.

FIG. 6C shows an example of a network storage information table 631 of the preferred embodiment of the present invention. This table is used to determine where a message or attachment is to be stored, where to later look for the message or attachment and whether the system administrator should be notified of storage problems. The table is made up of rows, which represent a storage unit, and columns, which represent the attributes of a storage unit.

The network storage information table 631 includes eight columns of information. The first column, start date 632, specifies the date of the first message in the storage unit. The ID start 633 and ID stop 634 columns specify the range of hashes that can be stored in the storage unit, using a portion of the computed hash. This range must be unique and not overlap with the hash range of any other storage unit for writable storage units. All hash ranges must be present in the network storage information table 631, so that for any computed hash of a message or attachment, it can be written to one and only storage unit, to prevent duplicate copies of messages or attachments.

The location 635 and storage partition 636 columns are used to identify the physical location of a storage unit. As seen in FIG. 6B, the location 635 corresponds to a storage network, for example the first row shows a location of London1 622. The storage partition 636 corresponds to a portion of that storage network. Using location 635 and storage partition 636, the available storage networks can be broken up into a grid of storage units.

The state column 637 holds the current state of the storage unit. Typical states include offline, ready, read only and full. The free MB column 638 shows the amount of free space available. Column 639 shows the current access time in ms, used in staging message retrievals.

Rows 640 and 641 show examples of read only storage units. These storage units captured messages in the past, but are no longer used for new messages. This is needed to allow changes to the storage grid. While using a storage network such as SAN allows the addition of additional storage without modifying the actual network configuration, there are times when a modification of the storage grid is desired, such as when adding remote storage networks or modifying the balance of the storage. After modifying the network storage information table 631 to reflect the new storage grid, new messages will go to the desired storage unit, but old messages will hash to the wrong storage unit. One solution is to move all the old messages to the storage unit it hashes. The preferred embodiment of the invention simply leaves the old messages on the original storage unit, but list the storage unit in the network storage information table 631 as read only. Message retrieval will then search each storage unit whose ID range matches the message that describes its location, using the start date column 632 as a hint.

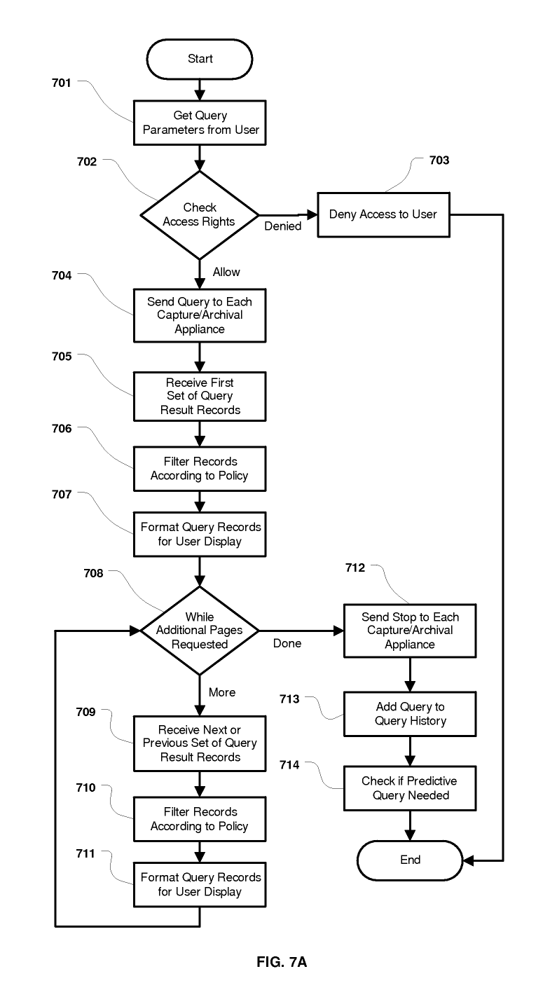

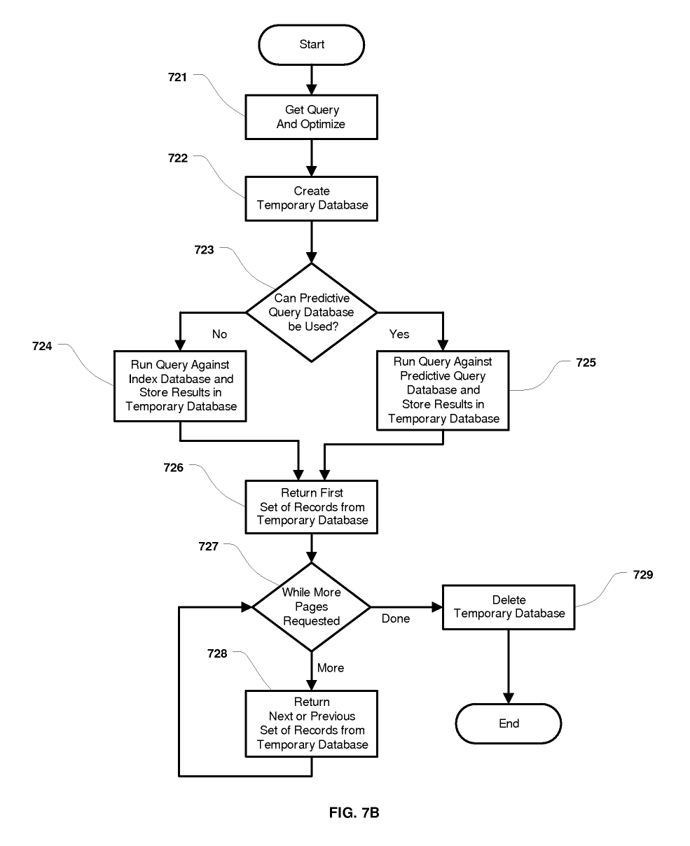

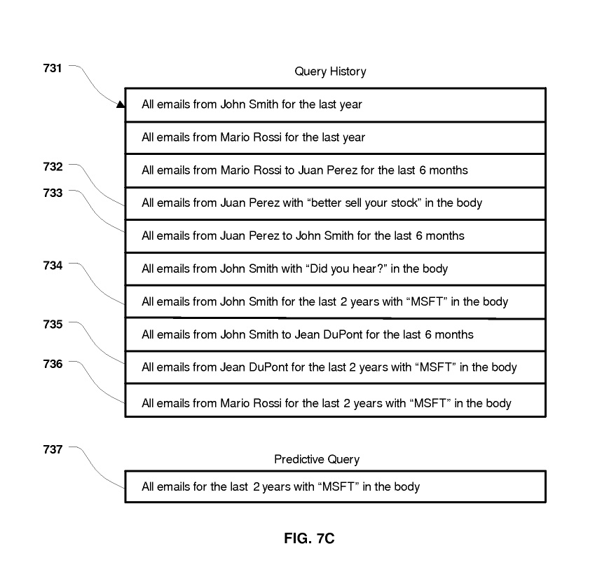

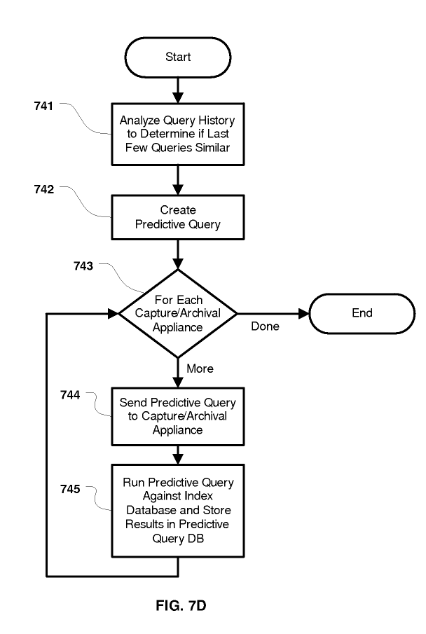

The diagrams and illustrative examples in FIG. 7A, FIG. 7B, FIG. 7C and FIG. 7D describe the operation of the preferred embodiment of the message query/retrieval 209 component of the present invention. FIG. 7A is a block diagram illustrating a method of the present invention for executing a user query and returning interactive results. In step 701, the user submits a query via the user interface 210. The query is submitted as a simple parameter list, such as “all emails from John smith in the last year.” In step 702, the user's access rights are checked to see if this particular user has the right to run queries against the index database. If the user lacks the right to run queries against the index database, the user is informed of the restriction in step 703 and processing completes. If the user has the right to run queries against the index database, in step 704, the query is sent to each capture/archival appliance in the electronic communications network, including the one the query originated on. The execution of the query on a capture/archival appliance is described in more detail in FIG. 7B. In step 705, the first set of query records are return by each capture/archival appliance in the electronic communications network and are inserted into a temporary database for sorting purposes. In step 706, the user's access rights are again checked to determine if any filtering of the results should take place. For example, if the user is a member of the compliance department, the user might have the right to view anyone's messages, except for messages belonging to the executives group or to the user's manager. After filtering, in step 707 the query records are formatted for display and sent to the user for viewing via the user interface 210.

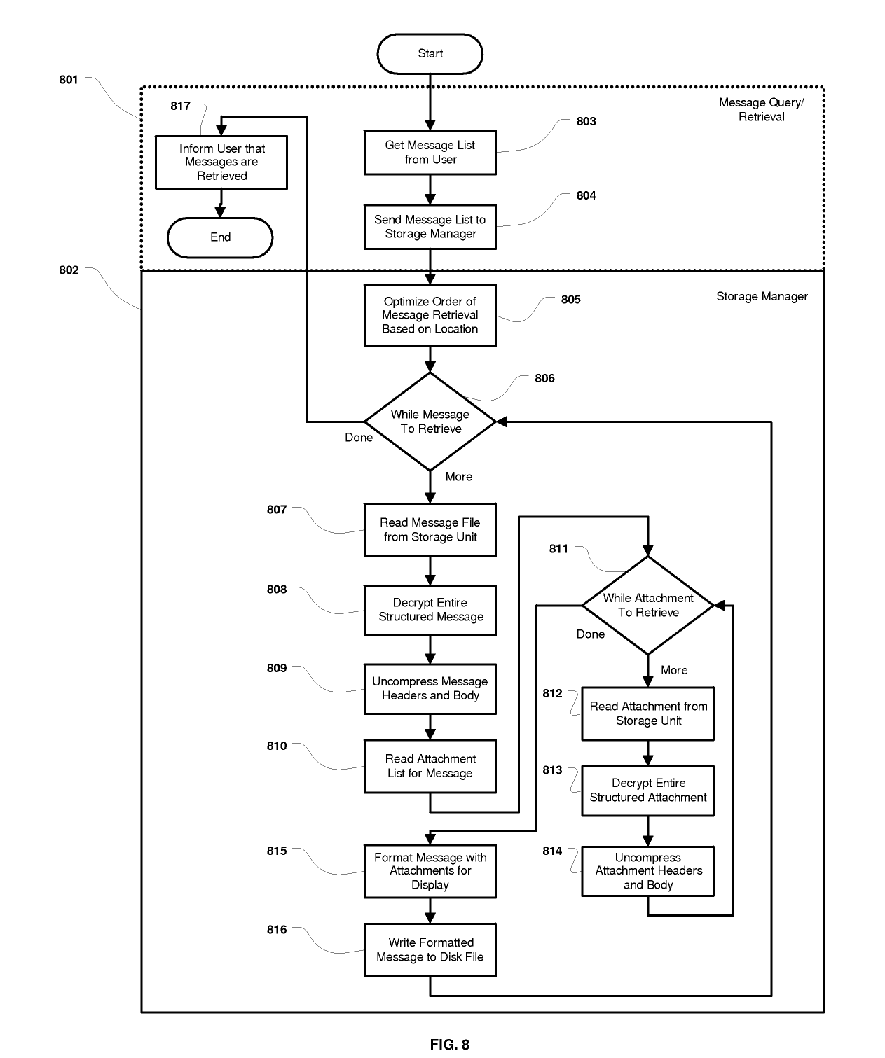

Since a query can return a large volume of results, the results are displayed a page at a time. After the first page is displayed, in step 708, the user can interactively view other pages of query results by requesting another page, either prior or after the current page. In step 709, the query records corresponding to the desired page are retrieved from each capture/archival appliance in the electronic communications network. In step 710, in the same process as step 706, the query records are filter based on the user's access rights. In step 711, the filtered query records are formatted for display and sent to the user for viewing via the user interface 210. During this interactive session, the user can also view or save any number of messages from the query. The process of retrieving messages from the query is further described in FIG. 8.

When the user is done viewing the results of this query, in step 712, each capture/archival appliance in the electronic communications network is informed that the query results are no longer needed and it is safe to delete the result set. In step 713, the query is added to the query history 731, which keeps track of the last few queries. In step 714, a check is performed to see if a predictive query should be performed.

FIG. 7B is a block diagram illustrating a method of the present invention for executing a query against the index database of archived electronic messages for a single instance of the invention. In step 721, the capture/archival appliance receives the query sent in step 704. The query is converted into SQL and optimized. In step 722, a temporary database is created to store the query results. Alternately, the results can be stored in a table within the index database. In step 723, the query is analyzed to see if it can be run against the smaller predictive query database. This is determined by checking if the predictive query results are a superset of the current query's results. The method of this analysis will become readily apparent in the discussion for FIG. 7C and FIG. 7D.

If the predictive query results are not applicable, in step 724, the query is run against the entire index database and the results stored in the temporary database. If the predictive query results are applicable, in step 725, the query is run against the predictive query database and the results stored in the temporary database. In step 726, the first set of records from the query result is returned to step 705 of the capture/archival appliance that initiated the query. In step 727, the capture/archival appliance waits for requests for other pages of query results, which is directed by step 708 of the capture/archival appliance that initiated the query. When a request is received, in step 728, the capture/archival appliance returns the requested page of results to step 709 of the capture/archival appliance that initiated the query. In step 726, when the capture/archival appliance is informed the query results are no longer needed, in step 729, the temporary database is deleted and processing ends.

A predictive query is a performance optimization used to reduce the amount of data a query is performed against. It can be described as a superset of the results from a batch of related queries. Instead of running a query against the entire index database, a related query can be run against the much smaller predictive query results database. FIG. 7C shows an example of a query history 731 and a predictive query 7327 derived from it. As can be seen, many times when a user is performing a series of queries, the queries form a pattern that can allow the invention to predict what the next few queries will contain. For example, the last few queries 734, 735 and 736 in the query history 731 seem to show that the user is looking at emails with “MSFT” from various senders and the user is only going back 2 years in the archive. It can be predicted the next query to be run will be against another user for all emails from the last 2 years containing “MSFT”. To optimize, predictive query 737 is run and the next query, if in the form predicted, is run against the predictive query results. In an alternative embodiment, the predictive query could be better refined, by trying to predict a query the user will run. For example, earlier in the query history 731, the user was researching the activities of Juan Perez 732 and 733. Taking into account the logic used to create predictive query 737, it can be predicted that the user will eventually execute query “All emails from Juan Perez for the last 2 years with “MSFT” in the body.” Note that there can be multiple predictive queries present at any time and that each query is periodically updated (and therefore the predictive query results modified) as the query history changes.

FIG. 7D is a block diagram illustrating a method of the present invention for executing predictive queries. In step 741, the query history 731 is analyzed to see if the last few queries form a pattern that can be used to create a predictive query. As noted earlier, the predictive query results will be a superset of the results from the queries used in the pattern. In step 742, the predictive query is created based on the pattern analysis in step 741. In step 743, each capture/archival appliance in the electronic communications network is directed to run the predictive query, including the capture/archival appliance the predictive query is created on. In step 744, the predictive query is sent to a capture/archival appliance. In step 745, the predictive query is run against the index database on the capture/archival appliance and stored in the predictive query database. When all capture/archival appliances in the electronic communications network have run the predictive query, processing ends.

FIG. 8 is a block diagram illustrating a method of the present invention for retrieval of archived electronic messages. The steps within 801 are performed within the message query/retrieval 209. The steps within 802 are performed within the storage manager 206.

In step 803, the user sends a list of desired messages to the message query/retrieval 209. Each element in this list contains an index database record which describes a single message. Included is the message's hash, which is used to locate the message. In step 804, the list of messages is forwarded on to the storage manager 206. In step 805, the list is ordered for retrieval based on the characteristics of the message and the storage units, and on the number of messages that can concurrently be retrieved. The idea is to both minimize the time to retrieve the list of messages and to show the user that progress is occurring in retrieving the messages. As an illustrative example only, if there was a limit of five messages being retrieved concurrently, and the five messages currently being retrieved are the largest in the list of messages, and the five messages are also being retrieved from the slowest storage units, the user might think the retrieval process “hung” and terminate it unnecessarily. Additionally, if the message retrievals are not staged properly, the five messages currently being retrieved could all come from a single storage unit, which would degrade the performance of the storage unit compared to what would be achieved from retrieving messages from five different storage units.

In step 806, the list of messages is iterated through and steps 807 through 816 are performed. In step 807, the message file is found on the storage unit using message hash. As described earlier in the discussion of FIG. 6C, the hash of the message is used to determine which storage unit the message is written to, based on the range of hashes specified by the ID start 633 and ID stop 634 columns in the ID network storage information table 631. Since the storage grid could be modified as new storage locations are added or removed, more than one storage unit might have to be checked before the message file is found. The start date 632 column can be used to bypass storage units that didn't start receiving messages until after the date of the current message. As described earlier in the discussion of step 611 of FIG. 6A, the message is written to the selected storage unit as a file with the message hash as the name of the file. Therefore, using the message hash and the ID network storage information table 631, the message file is found and read from the storage unit.

In step 808, the message is decrypted by reversing the method used to encrypt the file in step 610. This involves removing the public key encrypted session key at the start of the message, decrypting the session key using the private key and decrypting the rest of message using the session key. In step 809, the headers 505 and body 506 sections of the message are decompressed. The original structured message 501 from step 402 is now available.

In step 810, the list of attachments 504 is read from the structured message 501. In a loop in step 811, each attachment has in the list of attachments 504 is processed in steps 812, 813 and 814. As can be seen, the processing of each attachment follows a similar path as that of the message. In step 812, the attachment file corresponding to the attachment hash is found and read from the storage unit in the same manner as described for the message in step 807. In step 813, the attachment is decrypted in the same manner as the message in step 808. In step 814, the headers 505 and body 506 sections of the attachment are decompressed. The original structured attachment 501 from step 402 is now available. After the last attachment is processed, the loop is complete and step 815 is performed. In step 815, the message and its attachments are formatted for display. In step 816, the formatted message and attachments are appended to a disk file. After all messages in the list of messages are processed, control is passed back to message query/retrieval 209. In step 817, the user is informed that the requested messages have been retrieved and are available for viewing.

Several alternative embodiments to message query/retrieval 209 description can be readily apparent to anyone knowledgeable in the art. For example, the user could select a list of messages to be retrieved and have them saved directly to a local archive file. In another alternative, the user could simple run a query and have the entire results of the query retrieved and saved to a local archive file, bypassing the need to view the query results and select the messages to be retrieved.

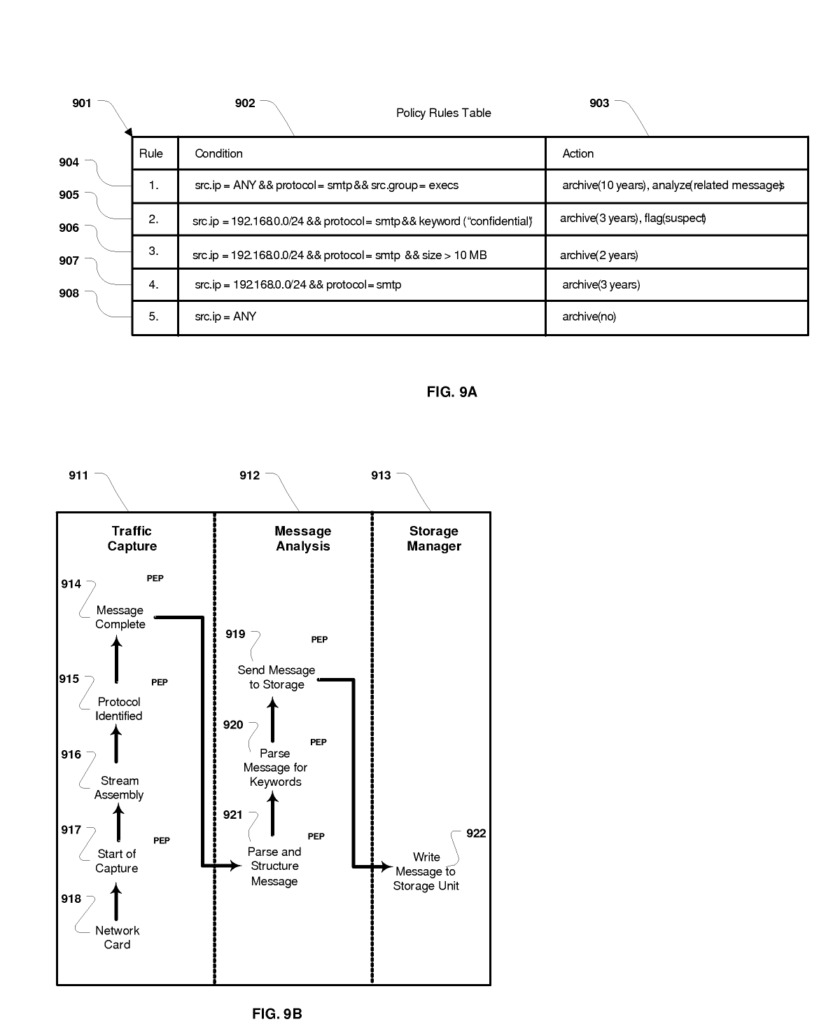

FIG. 9A and FIG. 9B further illustrate the policy 213 component. The methods of the policy 213 component are described in greater detail in FIG. 3, FIG. 4 and FIG. 7A, as it is more informative to describe the workings of the policy 213 in conjunction with the workings of the traffic capture 202, message analysis 205, and message query/retrieval 209 components.

A policy consists of a set of rules that define what actions to take based on a set of conditions. FIG. 9A shows an example of a policy rule set of the preferred embodiment of the present invention. A policy rule table 901 contains an ordered set of rules, such as those shown as 904, 905, 906, 907 and 908. Each rule consists of a compound or simple condition 902 and one or more actions 903. A compound condition consists of two or more simple conditions combined using a logical operator. Some examples of simple conditions include the source IP address of a message, the transport protocol used, the LDAP group the sender belongs to or a specific keyword found in the message body. Rules are evaluated at a Policy Enforcement Point (PEP). The PEPs located in the system are described in FIG. 9B. At each PEP, the set of policy rules are evaluated in order until a condition matches. When a match occurs, policy rule evaluation is stopped and the actions from the matched rule relevant to the current PEP are executed. Note that the last rule policy rule table 901 should by default match anything, so a default action can be taken.

As an illustrative example only, using the example policy rule table 901, a SMTP based message of size 24 KB is received on the 192.168.0.0/24 subnet. At steps 302, 304 and 307, the policy rules are evaluated and rule 907 matches, so the message is completely captured. The message is parsed in step 404 and found to contain the keyword “confidential” in the message body. The policy rules are again evaluated and now rule 905 matches. The message is flagged as suspect and the archive retention period is set to 3 years.

FIG. 9B is a flow diagram describing the Policy Enforcement Points (PEP) of the preferred embodiment of the present invention. Section 911 includes the three PEPs that are located in the traffic capture 202 component. Section 912 includes the three PEPs that are located in the message analysis 205. Section 913 shows the message being sent to the storage manager 206. The multitude of PEPs is to optimize performance by dropping unwanted messages as early as possible and restricting additional analysis to messages of particular interest.

As described earlier, network packets comprising an electronic message are captured at the network interface card 918 and reconstructed into the sent electronic message by the pseudo TCP/IP stack 203. When the first part of the message is received 917, PEP occurs to determine whether to continue capturing the message. The message stream continues to be assembled 916 until the protocol can be identified 915, at which time another PEP is taken to determine whether to continue capturing the message. After the entire message is received 914, a final PEP is performed in the traffic capture 202 to determine if the message should be dropped before passing it on to the message analysis 205.

Another PEP is taken after the message analysis 205 parses the captured message into a structured format 501 and separates out the attachments into structured attachments 921. After the message and attachments are parsed for keywords 920, another PEP is taken. In step 919, prior to sending the message to the storage manager 206 for writing to a storage unit 922, a final PEP is taken to determine the message's storage attributes.

In additional to the policy rules PEPs, the policy 213 component restricts user's access to the archived messages. This can be implemented as an LDAP database, populated by a list of users that are allowed access to the archived messages. When a user submits a query to the message query/retrieval 209, the policy 213 checks if the user is in the LDAP database. If the user does not exist, access to the archived messages is denied. User attributes with in LDAP database is used to restrict which messages the user can access, thereby filtering any query results, as described in step 706.

While the above description contains many specificities, these should not be construed as limitations on the scope of the invention, but rather as exemplification of one preferred embodiment thereof. Numerous alternative embodiments will be readily apparent to those skilled in the art without departing from the spirit and scope of the invention.

What is claimed is:

1. A method for selecting a storage location based on the hash value of a electronic message, the method comprising of:
processing said electronic message though a hashing algorithm to create a unique said hash value; and
partitioning each storage device in a storage network into individually accessible units; and
providing a storage grid wherein each said individually accessible unit is represented as a storage unit; and
providing a network storage information table that comprises said storage units; and
associating an ID range to each said storage unit such that for any said hash value, one and only one said storage unit is associated with said hash value; and
selecting a said storage unit from said network storage information table based on the said hash value of the said electronic message compared to the said ID range of said storage unit; and
storing said electronic message on the selected said storage unit.

2. A method of claim 1, wherein the said electronic messages are a plurality of SMTP, Microsoft Exchange, MSN IM, Yahoo IM, SMS, HTTP, VoIP, RSS and other messaging protocols.

3. A method of claim 1, wherein the said hashing algorithm is MD5.

4. A method of claim 1, wherein a redundancy of said storage units is associated with any said hash value.

5. A method of claim 1, wherein a plurality of said individually accessible units are represented as a single said storage unit.

6. A method of claim 1, wherein said network storage information table is modified wherein additional said storage devices are added to said storage network, by marking the current said storage units with said ID range as read only, partitioning all said storage devices in the said storage network into new individually accessible units, creating new storage units using said individually accessible units and associating a new ID range to each said storage unit.

7. A method of claim 1, wherein said network storage information table is modified wherein additional said storage devices are added to said storage network, by partitioning the additional said storage devices in the said storage network into new individually accessible units, creating new storage units using said individually accessible units and associating a ID range associated with a current storage unit to the to said new storage unit such that said new storage unit and said current storage unit are both associated to the same said ID range.

8. A method of claim 6, wherein said current storage unit is selected based on the amount of free disk space available.

9. A method of claim 1, wherein said network storage information table is modified wherein one or more said storage devices are removed from said storage network, by marking the current said storage units with said ID range as read only, partitioning all said storage devices in the said storage network into new individually accessible units, creating new storage units using said individually accessible units and associating a new ID range to each said storage unit.

10. A method of claim 1, wherein the said storage networks comprises a plurality of NAS, SAN, iSCSI and SCSI said storage devices.

11. A method of claim 1, wherein the said electronic message is written to a file with the said hash value as its name.

12. A device for selecting a storage location based on the hash value of a electronic message, comprising of:
an hashing device to create a unique said hash value from a electronic message; and
a storage grid wherein each storage device in a storage network is partitioned into individually accessible storage units; and
a network storage information table that comprises said storage units, such that each said storage unit is associated with a unique ID range so that for any said hash value, one and only one said storage unit is associated with said hash value; and
a storage manager that selects a single said storage unit from said network storage information table based on the said hash value of the said electronic message compared to the said ID range of said storage unit and stores said electronic message on the selected said storage unit.

13. A method for converting an electronic message into a structured message, the method comprising of:
parsing said electronic message into message parts based on the type of the said electronic message; and
separating out all embedded attachments stored within said electronic message; and
storing said embedded attachments at a separate location; and
adding meta data information concerning the said electronic message to said separated electronic message; and
adding information about said separate location of said embedded attachments to said separated electronic message in order that said embedded attachments can be found when retrieving said electronic message; and
adding item pointers to the locations of said message parts within said separated electronic message; and
thereby converting said electronic message into a generic structured message format such that each said message part is easily found and said embedded attachments can be de-duplicated.

14. A method of claim 13, wherein the said meta data information concerning the said electronic message comprises of the messaging protocol type, the period to archive the said electronic message, the uncompressed size of the said electronic message and flags describing the characteristics of the said electronic message.

15. A method of claim 13, wherein the types of the said electronic messages are a plurality of SMTP, Microsoft Exchange, MSN IM, Yahoo IM, SMS, HTTP, VoIP, RSS and other messaging protocols.

16. A method of claim 13, wherein said electronic message in said generic structured message format is compressed.

17. A method of claim 13, wherein said electronic message in said generic structured message format is encrypted.

18. A method of claim 13, wherein the types of said embedded attachments are a plurality of spreadsheet, presentation and document email attachments.

19. A method of claim 13, wherein the said embedded attachment is discarded if a duplicate of the said embedded attachment can be found in storage, whereby the location of said duplicate is added to the said separated electronic message.
